(19) United States
(12) Patent Application Publication
(10) Pub. No.: US 2024/0054225 A1
(43) Pub. Date: Feb. 15, 2024

(54) INTELLIGENT SERVICE SECURITY ENFORCEMENT SYSTEM

(71) Applicant: Facebook, Inc., Menlo Park, CA (US)

(72) Inventors: Luhui Hu, Bellevue, WA (US); Can Lin, Bellevue, WA (US); Xiaohua Jiang, Medina, WA (US)

(21) Appl. No.: 17/316,296

(22) Filed: May 10, 2021

Related U.S. Application Data
(60) Provisional application No. 63/024,900, filed on May 14, 2020.

(51) Int. Cl. G06F 21/57; G06F 11/36; G06F 8/77

(52) U.S. Cl. CPC G06F 21/577; G06F 11/3688; G06F 8/77; G06F 2221/033

(57) ABSTRACT

A method and system are described. The method includes determining, in a development phase of a software service, whether the software service complies with a first policy in response to a request. The method also monitors, in at least one of a testing phase or a production phase of the software service, whether operation of the software service complies with a second policy. Based on the determining and the monitoring, an indication of a service vulnerability is generated in response to the software service failing to comply with the first policy in the development phase or failing to comply with the second policy in the at least one of the testing phase or the production phase.

### CROSS REFERENCE TO OTHER APPLICATIONS

This application claims priority to U.S. Provisional Patent Application No. 63/024,900 entitled INTELLIGENT SERVICE SECURITY ENFORCEMENT SYSTEM filed May 14, 2020 which is incorporated herein by reference for all purposes.

### BACKGROUND OF THE INVENTION

Threat modeling analysis (TMA) is a process used to identify and reduce security risks. There are five major processes in TMA: define security goals, diagram the application being analyzed, identify threats, mitigate the threats, and validate that the threats have been mitigated. STRIDE (Spoofing, Tampering, Repudiation, Information disclosure, Denial of service, and Elevation of privilege) is a widely used TMA methodology. STRIDE addresses the threats that violate the corresponding desirable properties: authenticity (threat: spoofing), integrity (threat: tampering), non-repudiability (threat: repudiation), confidentiality (threat: information disclosure), availability (threat: denial of service), and authorization (threat: elevation of privilege). However, TMA generally and STRIDE in particular are still manually performed in most cases. Further, TMA and STRIDE are primarily used in the context of developing software. Although there are some improvements in this process, such as “smart” diagram tools, it is still a human-driven, manual process used in development of software. Consequently, an improved mechanism for mitigating security risks, particularly for software services, is still desired.

### BRIEF DESCRIPTION OF THE DRAWINGS

Various embodiments of the invention are disclosed in the following detailed description and the accompanying drawings.

FIG. 1 is a diagram depicting an environment in which an embodiment of a service security enforcement system is utilized.

FIG. 2 is a diagram depicting an embodiment of a service security enforcement system.

FIG. 3 is a diagram depicting operation of an embodiment of a service security enforcement system during testing or production.

FIG. 4 is a functional diagram illustrating a programmed computer system for executing at least some of the processes in accordance with some embodiments.

FIG. 5 is a flow-chart depicting an embodiment of a method for performing threat modeling analysis for software services.

FIG. 6 is a flow-chart depicting an embodiment of a method for performing TMA for software services using tags.

FIG. 7 is a flow-chart depicting an embodiment of a method for performing TMA using analysis of software services.

FIG. 8 is a flow-chart depicting an embodiment of a method for performing TMA for software services during the testing and/or production phases.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Threat modeling analysis (TMA) is used to identify and mitigate security risks. Traditionally, there are five major steps in TMA: define security requirements, diagram the application, identify threats, mitigate the threats, and validate that the threats have been mitigated. STRIDE (Spoofing, Tampering, Repudiation, Information disclosure, Denial of service, and Elevation of privilege) is a TMA technique for addressing threats that violate the following properties: authenticity, integrity, non-repudiability, confidentiality, availability, and authorization. Although the TMA core methodology can be effective, TMA remains primarily manual. In part because the process is manual, TMA may be time-consuming and error prone. STRIDE is also still primarily manual in nature and so may suffer from similar drawbacks. Furthermore, TMA tends to be restricted to the development phase and exhibits little variation between users the methodology. Thus, TMA and STRIDE may be limited in their ability to manage potential threats.

TMA, including STRIDE, may suffer from additional disadvantages in the context of software services. Software services start at the design and development phase (“development phase”), transition to the testing and beta phase (“testing phase”), and move to the production phase. Although TMA may prevent or reduce service vulnerabilities in advance (i.e. the development phase), runtime performance of the software service in the production phase is generally more important. Software services are more dynamic during the runtime. Unfortunately, there may be limited connection between runtime (production or testing phase) results and TMA performed in the development phase. It may also be difficult to scale the five step procedure of TMA for a large range of services. Thus, software services may remain vulnerable to threats during runtime.

In addition, software service development benefits greatly from agility. Software services are iterated and released frequently. For example, software services may be released weekly or even daily. Stated differently, software services may be subject to continuous integration (CI) and/or continuous deployment (CD). The CI/CD nature of software services is in contrast to the development of traditional software, for which TMA was originally designed. It may, therefore, be inefficient to employ TMA's five steps at each release for a software service. Thus, security for software services may be compromised.

Because it is a manual process, TMA depends on senior engineers or security experts to define security goals, identify security issues, design threat mitigation features and/or perform other related functions. TMA is, therefore, primarily knowledge-based or experience-based and slow rather than data-driven and performed in real time. Transferring this knowledge and experience quickly and efficiently is challenging. Although the TMA process might be used in development, for CI/CD, the time taken to adequately perform TMA may be longer than desired for subsequent releases. As a result, subsequent iterations of the software service may be more vulnerable. Thus, TMA may be less effective in addressing security issues for software services.

Software services may also be complex and desired to be scalable. For example, a software service may be implemented in different languages, packed with more than one language, serve a huge number of clients with some unexpected bursts, and/or may be distributed geographically with a range of dependent services. The defining and diagramming steps in TMA that attempt to identify and determine the scope of potential vulnerabilities are extremely difficult tasks. Identifying potential security vulnerabilities may be particularly challenging if there are dependent changes or upgrades desired to be developed and deployed in parallel with TMA. Consequently, an improved mechanism for mitigating security risks, particularly for software services, is still desired.

A method and system for improving software service security are described. The method includes determining, in a development phase of a software service, whether the software service complies with a first policy in response to a request. The method also monitors, in at least one of a testing phase or a production phase of the software service, whether operation of the software service complies with a second policy. Based on the determining and the monitoring, an indication of a service vulnerability is generated in response to the software service failing to comply with the first policy in the development phase or failing to comply with the second policy in the testing phase and/or the production phase. In some embodiments, security information for the software service is stored. The security information includes the service vulnerability. Other security information may also be stored. This security information may be used later in analyzing the compliance of other (or the same) software service(s).

In some embodiments, determining, in the development phase, whether the software service complies with the first policy may utilize tags. In some such embodiments, the tag for the first policy is detected in the software service. The first policy is identified based on the tag. It is also determined whether the software service complies with the first policy. In some embodiments, determining, in the development phase, whether the software service complies with the first policy may utilize an analysis. In some such embodiments, the software service is analyzed to identify properties for the software service. It is determined whether the properties match characteristics corresponding to the first policy. In response to the properties of the software service matching the characteristics for the first policy, it is determined whether the software service complies with the first policy. To determine whether the properties of the software service match the characteristics for the policy, a database including security information for software services is accessed.

In some embodiments, monitoring, in the testing and/or production phase(s), whether the software service complies with the second policy may utilize a log. The log is generated during operation of the software service in the testing phase and/or the production phase. The method includes inspecting the log for the software service. Based on the log, it is determined whether the software service complies with the second policy.

In some embodiments, the first policy (for which compliance is checked for the development phase) and the second policy (for which compliance is checked during the testing and/or production phases) are the same. Stated differently, compliance with a policy may be determined throughout multiple phases of the development, testing and production cycle. In some embodiments, the first policy and the second policy differ. Thus, compliance with different policies may be determined at different phases in the cycle. In some embodiments, the first and/or second policies are enforced in response to the software service failing to comply with the policy or policies one or more of the development, testing and production phases.

A system including a memory and a processor coupled to the memory is described. The processor is configured to determine, in a development phase of a software service, whether the software service complies with a first policy in response to a request. The processor is also configured to monitor, in a testing phase and/or a production phase of the software service, whether operation of the software service complies with a second policy. The processor generates, based on the determination and the monitoring, an indication of a service vulnerability in response to the software service failing to comply with the first policy in the development phase or failing to comply with the second policy in the testing and/or production phase(s). In some embodiments, the first policy and the second policy are the same. In other embodiments, the first and second policies differ. In some embodiments, the processor is configured to store security information for the software service, for example in the memory. The security information includes the service vulnerability. The processor may also be configured to enforce the first policy in response to the software service failing to comply with the first policy in the development phase and/or to enforce the second policy in response to the software service failing to comply with the second policy in the testing and/or production phase(s).

To determine whether the software service complies with the first policy, the processor may be configured to detect a tag for the first policy in the software service, identify the first policy based on the tag, and determine whether the software service complies with the first policy. In some embodiments, to determine whether the software service complies with the first policy, the processor is configured to analyze the software service to identify properties for the software service. The processor also determines whether the properties match characteristics corresponding to the first policy, and determines whether the software service complies with the first policy in response to the properties matching the characteristics. In some embodiments, to determine the match, the processor is configured to access a database including security information for software services. To monitor whether the software service complies with the second policy, the processor may be configured to inspect a log for the software service. The log is generated during operation of the software service in the testing phase and/or the production phase. The processor is also configured to determine, based on the log, whether the software service complies with the second policy.

A computer program product embodied in a non-transitory computer readable medium is also described. The computer program product includes computer instructions for determining, in a development phase of a software service, whether the software service complies with a first policy in response to a request. The computer program product also includes instruction for monitoring, in a testing phase and/or a production phase of the software service, whether operation of the software service complies with a second policy. The computer program product also includes instructions for generating, based on the determining and the monitoring, an indication of a service vulnerability in response to the software service failing to comply with the first policy in the development phase or failing to comply with the second policy in the testing phase and/or the production phase. In some embodiments, the computer program product also includes computer instructions for storing security information for the software service. The security information includes the service vulnerability. The computer program product may also include computer instructions for enforcing the first policy in response to the software service failing to comply with the first policy in the development phase and/or enforcing the second policy in response to the software service failing to comply with the second policy in the testing and/or production phases.

In some embodiments, the computer instructions for determining whether the first policy is complied with include instructions for analyzing the software service to identify properties for the software service, for determining whether the properties match characteristics corresponding to the first policy, and for determining whether the software service complies with the first policy in response to the properties matching the characteristics. The computer instructions for monitoring whether the second policy is complied with may include instructions for inspecting a log for the software service and determining, based on the log, whether the software service complies with the second policy. The log is generated during operation of the software service in the testing and/or production phases.

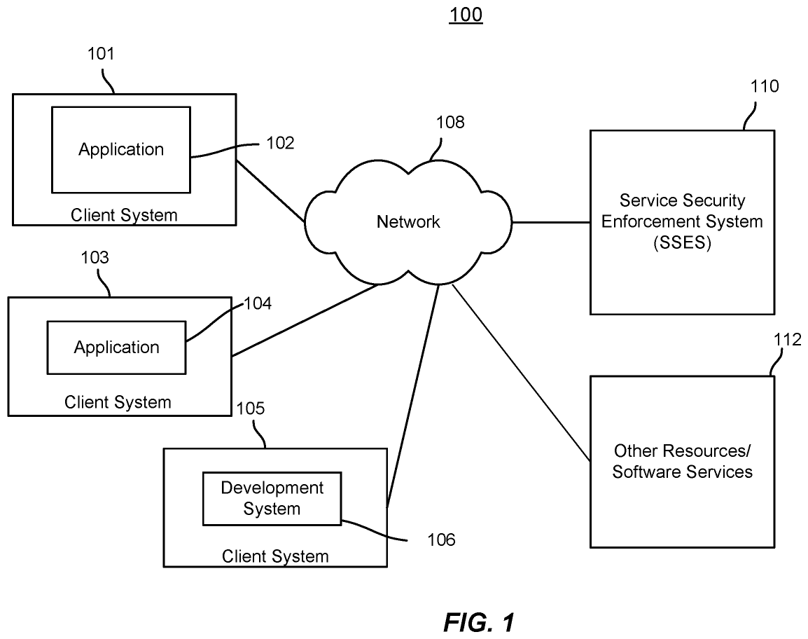

FIG. 1 is a diagram depicting an environment 100 in which an embodiment of a service security enforcement system (SSES) 110 is used. For example, environment 100 includes systems that may be used to in the development, testing and/or production phases for software service(s) with which SSES 110 is desired to be used. Environment 100 thus includes client systems 101, 103, and 105 on which applications 102 and 104 and development system 106, respectively reside. Although three systems 101, 103 and 105, two applications 102 and 104 and one development system 106 are shown for clarity, environment 100 may include another number of any or all of these. Resources, such as data stores, servers, software services that have been deployed and/or other resources (“resources”) 112 in environment 100 are also shown. Users access resources 112 via applications 102 and 104 on client systems 101, and 105, respectively. Similarly, developers (not shown in FIG. 1) access resources 112 via development system 106 on client system 105.

SSES 110 is utilized in providing TMA for software services developed, tested, and/or deployed in environment 100. Thus, SSES 110 performs TMA in one or more of the development phase, the testing phase, and the production phase of the software services' life cycle. In some embodiments, SSES 110 performs TMA in all phases of the life cycle. In the development phase, SSES 110 determines whether the software service complies with one or more applicable policies. For example, in response to a request, SESS 110 may determine one or more policies that are related to the software service and determine whether or not the software service represents a security vulnerability for (e.g. violates) the policy or policies. In some embodiments, the request is a request to compile the software service. In some embodiments, SSES 110 determines compliance in response to other and/or additional requests. For example, the request may simply be to check the software service being developed. In some embodiments, SSES 110 utilizes one or more bots designed to check software services being developed in order to determine compliance with one or more policies. In some embodiments, the determination of whether the software service violates policies may be made utilizing tags used in annotations in the software service. When processing the code for the software service, SSES 110 detects one or more tags. SSES 110 identifies to which policy or policies the tag(s) are related and whether the software service in which the tags are embedded violates the policy/policies.

In some embodiments, SSES 110 determines whether the software service represents a security vulnerability by otherwise analyzing the software service in the development phase. The software service may be analyzed to identify properties of the software service, one or more policies that have characteristics corresponding to these properties may be identified, and the software service's compliance with the policy or policies determined. For example, the software service being developed on development system 106 may be similar to other software services that have previously been developed in environment 100. It may be determined whether the software service matches pattern(s) of previously developed software service(s). The software service may be checked for compliance with policies applicable to the previously developed, matching software service(s). The matching previously developed software service(s), matching policy or policies and/or other security information may thus be stored (e.g. in a database) to be used in analyzing the software service. In some embodiments, at least part of this analysis, such as the matching of properties and/or characteristics, may be performed via machine learning.

SSES 110 may also perform TMA in the testing phase and/or production phase of the software service. Thus, SSES 110 determines whether the software service presents one or more security vulnerabilities in phase(s) other than the development phase. In some embodiments, SSES 110 monitors operation of software services and determines compliance with one or more policies during runtime in the testing and/or production phases. During testing and/or production, the analysis described above with respect to the development phase may be carried out. Thus, properties of the software service during operation may be detected, the properties matched to corresponding characteristics of policies, and compliance with the policies determined. In addition, if tags were used in the development phase, compliance with the policy or policies corresponding to the tags may also be monitored in the testing and/or production phases. In some embodiments, SSES 110 may utilize a log generated during operation of the software service to perform TMA. SSES 110 may inspect the log for the software service and, based on the contents of the log, determine whether the software service complies with the appropriate policy or policies. For example, SSES 110 may identify one or more feature(s) in the log that correspond to violations of policies. Based on these features, SSES 110 may determine that the software service violates the policies. SSES 110 may also match features in the software service's log to those of previously developed software services, identify the applicable polices based on the previously developed software services, and check the software service for compliance with these applicable policies.

If it is determined in the development, testing, and/or production phase that the software service represents one or more security vulnerabilities, a response indicating a service vulnerability is generated. In some cases, the response may simply be a notification, or alert. For example, in the development phase, SSES 110 may notify the developer that the software service does not comply with the security requirements for environment 110. In some embodiments, changes to the software service may be suggested or made. If the security vulnerability is sufficiently serious, the software service may not be tested and/or deployed until the vulnerability is corrected. In the testing and/or production phase, enforcement may take the form of alerting an administrator or other authorized individual, shutting down ports, blacklisting IP addresses, terminating operation of the software service, and/or taking other action.

Using SSES 110 TMA may be performed throughout the life cycle of the software service. TMA performed via SSES 110 is not limited to development. Compliance with the same or different policies may be determined at different phases of the life cycle. Stated differently, whether the software service complies with a particular policy may be determined for one or more phases of the life cycle. For example, compliance with authentication policies may be determined for the development, testing and production phases. Compliance with other policies, for example related to network traffic management, might only be determined in the testing or production phases. Thus, TMA may be completed in multiple phases of the life cycle of the software service. Further, the TMA may utilize information, such as a pattern of behavioral properties indicated by logs, obtained during use of SSES 110. Not only may these properties be discovered automatically (e.g. via bots) but the matching of these properties may be performed via machine learning. Thus, TMA may be adaptable, may be data driven, and may reduce or eliminate the reliance on manual procedures. In addition, TMA using SSES 110 may be more efficient, particularly in the testing and production phases. Further, SSES 110 may provide notification to the developer or other authorized user(s) of environment 110 and/or enforcement in response to a determination that the software service fails to comply with one or more policies. Thus, visibility into the security vulnerabilities presented by software services may be provided. Consequently, security for software services developed, tested, and or deployed in environment 100 may be improved.

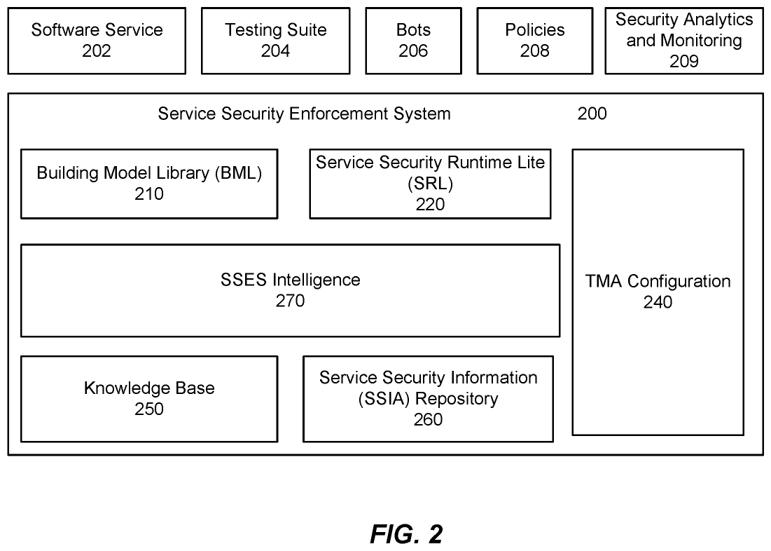

FIG. 2 depicts an embodiment of SSES 200. In some embodiments, SSES 200 indicates how SSES 110 is configured. However, other configurations are possible. For example, tasks indicated as being performed by particular component may be shared with other components and/or incorporated into different component(s).

SSES 200 is shown in conjunction with and interacts with portions of the environment. Thus, FIG. 2 depicts software service 202, testing suite 204, bots 206, policies 208, and security analytics and monitoring 209 that are part of the environment in which SSES 200 operates and/or is developed. Software service 202 may be a software service that is being developed, tested, and/or already released. A single software service 202 is shown and discussed. However, multiple software services may be present and consistent with the discussion of software service 202. Testing suite 204 includes one or more test cases against which software service 202 is tested during the testing phase. Bots 206 may be used to perform TMA tasks for software service 202. In some embodiments, bots 206 includes bots configured for runtime (e.g. testing and/or production phases) and bots configured for use during development. Bots 206 may also include one or more bots that are unrelated to TMA. When performing TMA in conjunction with SSES 200, bots 206 may be used in conjunction with building model library (BML) 210 and/or service security runtime lite (SRL) 220. The term policies, such as policies 208, includes individual policies (e.g. particular authentication policies for specific data repositories and authorization policies for a particular multitenant service) and the policy framework (e.g. token-based authentication) with which software service 202 is to comply. Security analytics and monitoring 209 is used to monitor the system during operation. SSES 200 is used to perform TMA in multiple phases of the life cycle (development, testing, and/or production phases) for software service 202.

SSES 200 performs TMA, automatically identifying service vulnerabilities during multiple phases of the life cycle (development, testing, and/or production) in a manner that is intelligent and data-driven. In some embodiments, SSES 200 utilizes the STRIDE methodology for TMA. In some embodiments another and/or additional methodology may be used. To perform TMA, SSES 200 utilizes BML 210, SRL 220, TMA configuration 240, knowledge base 250, service security information (SSIA) repository 260, and SSES intelligence 270.

BML 210 is used in performing TMA during the development phase. During development, BML 210 may be used in response to a request to compile or otherwise check software service 202 to determine whether software service 202 complies with policies 208. In some embodiments, BML 210 may be an extensible markup language (xml) module. BML 210 may be incorporated into or used in conjunction with build tools. BML 210 examines software service 202 (i.e. the source code for software service 202) so that it can be determined whether software service 202 is implemented to be consistent with certain policies 208. BML 210 may utilize tags and/or analysis of software service 202 being developed. For example, software service 202 may be examined for the presence of tags in the development phase. In some embodiments, BML 210 may employ bots 206 in examining software service 202. In response to the tags being detected, the policy or policies corresponding to the tags are identified, and software service 202 checked for compliance with the policy or policies. In some embodiments, BML 210 provides information related to the tags to SSES intelligence 270, which identifies the corresponding policies and determines whether software service 202 complies with the policies (e.g. using information in knowledge base 250). In some embodiments, BML 210 performs some or all of these functions (e.g. in conjunction with SSES intelligence 270 and/or using information in knowledge base 250). If the software service 202 does not comply with the policy or policies, response(s) indicating the service vulnerability (i.e. a security threat) is provided. For example, via BML 210, an alert may be provided to the developer and/or changes to the source code of software service 202 may be suggested.

For example, a software service class or interface may be annotated with a tag such as “AuthN_attribute” related to authentication (AuthN) or include an authentication annotation such as {authentication=on}. BML 210 (e.g. via a building tool or bot) encounters the tag when examining the code. BML 210 may check the software service's implementation of AuthN (e.g. using information regarding the requirements of the authentication policies from SSES intelligence 270 and/or knowledge base 250) to ensure that it is logically consistent with the relevant authentication policies. In some embodiments, BML 210 may provide the security information (e.g. the tag) to SSES intelligence 270. In response, SSES intelligence 270 automatically checks the software service's implementation of AuthN. If software service 202 does not comply with the desired authentication framework, then via BML 210 a response is provided to the developer indicating that the software service 202 presents a service vulnerability. In the authentication example above, the authentication policy or policies may require token-based authentication. If the software service 202 does not perform authentication using token-based authentication, then the developer is notified that the software service 202 has a service vulnerability for AuthN and may not proceed to testing and/or production. Similarly, a software service interface 202 may include an authorization tag, such as “AuthZ_attribute” related to authorization (AuthZ). In response to BML 210 encountering the tag, BML 210 and/or SESS intelligence 270 check the implementation of AuthZ by software service 202. For example, software service 202 might be a multitenant metadata service for which tenants are only allowed to access a subset of the metadata (e.g. their own metadata). In response to the AuthZ_attribute tag being encountered, the authorization implementation by software service 202 is checked by BML 210 and/or SSES intelligence 270 to determine whether the appropriate authorization protocol is used to restrict access to the metadata being stored by the software service. If the software service 202 does not use the requisite authorization, then BML 210 provides to the developer a notification that software service 202 has a security vulnerability related to AuthZ. Other and/or additional enforcement action might also be taken.

In some embodiments, BML 210 is used in the development phase for analyzing software service 202 to determine its properties. These properties of the code for software service 202 may be used to identify applicable policies having characteristics corresponding to the properties, and determining whether software service 202 complies with these policies. In some embodiments, a pattern of properties of software service 202 are matched to properties of other software services for which the applicable policies are known. Software service 202 may then be checked for compliance with these policies. For example, BML 210 may send to SSES intelligence 270 various features encountered in software service 202. SSES intelligence 270 determines whether these properties sufficiently match corresponding properties of other software services. If there is a match, SSES intelligence 270 determines the applicable policies. In some embodiments, the matching may be performed via machine learning. SSES intelligence 270 and/or BML 210 checks software service 202 for compliance with these policies. If software service 202 violates one or more of the policies, then indication(s) that software service 202 presents a service vulnerability are provided. For example, a notification may be sent (e.g. via BML 210) to the developer. The test cases in testing suite 204 used for software service 202 in the testing phase may be determined in an analogous manner. For example, the tags encountered in software service 202 by BML 210 may be compared to tags for other software services. It may be determined whether the tags in annotations for software service 202 match pattern(s) of tags in previously developed software service(s). This matching may also be performed by SSES intelligence 270 via machine learning. The test cases in testing suite 204 use with the previously developed matching software services are identified by SSES intelligence 270. These test cases may be used during the testing phase of software service 202.

SRL 220 is also used in performing TMA during the testing and/or production phases. In some embodiments, SRL 220 utilizes bots 206 to check the software services being run (in testing and/or production) for security vulnerabilities. In some embodiments, SRL 220 utilizes existing service logging in order to perform TMA. More specifically, SRL 220 may fetch the related information from logs generated during operation of the software service 202. This log information may be generated during the testing phase when test cases from testing suite 204 are utilized with software service 202. In the production phase, the log information is generated during actual use of software service 202. For example, the logs may be examined to determine the memory usage, data repositories accessed, authentication services used, and/or network traffic due to software service 202 being run. In response to particular information in the log or a pattern of information in the log, policies corresponding to software service 202 may be determined in a manner analogous to that described in the context of BML 210 and compliance of software service 202 determined. For example, SRL 220 may send some or all of the information from the logs for software service to SSES intelligence 270. SSES intelligence 270 may determine whether the data repositories and authentication services accessed by software service 202 sufficiently match those used by the previously developed software service. This matching may be performed via machine learning. If a match is found, SSES intelligence 270 may apply some or all of the same authentication policies (e.g. multifactor authentication) to software service 202. Thus, software service 202 is checked for compliance with these authentication policies. In some embodiments, information from the logs may be directly used to determine whether software service 202 complies with one or more policies. For example, information from the logs may indicate that software service has been repeatedly denied access to a data repository using a particular authentication framework. SSES intelligence 270 may determine from this that software service 202 violates the authentication policies for this data repository. Similarly, test cases from testing suite 204 used for the previously developed software service may be identified and used in the testing phase of software service 202. In some embodiments, service availability is tested by both client side and service side via SRL 220. On the service side, for example, SRL 220 may send STSD (security time-series data) to SSES intelligence 270 to monitor service availability. Because the software service is registered in SSES 200, software service 202 client-side testing can be performed to determine service availability.

Tags can also be used by SRL 220 in the testing phase and/or production phase. The policies checked in the development phase due to the presence of the tag may also be checked during the testing and/or production phase(s). For example, the software class or interface may be annotated with the AuthN tag, as described above. This tag may be located during the development phase and the authentication implementation checked during the development phase. In addition, the operation of software service 202 may be checked for compliance with policies 208 relating to authentication during the testing phase and/or the production phase. SRL 220 may provide authentication information from the logs for software service 202 to SSES intelligence 270. SSES intelligence 270 may use this information to check software service 202 for compliance with authentication policies corresponding to the tag. If software service 202 does not comply with the desired authentication policies, then a response indicating that the software service 202 presents a service vulnerability is provided. In some embodiments, annotations regarding availability may cause SSES 200 to determine whether software service 202 includes an availability check during testing and/or production. Similarly, software service 202 may be annotated with a confidentiality tag if the software service is expected to receive encrypted responses. During testing, responses may be checked to determine whether the returned information is encrypted and/or whether correct encryption protocol is used.

SRL 220 functions in an analogous manner for the production phase. In some embodiments, the instance of software service 202 being run is checked for compliance with the desired policies. For example, software service 202 is checked during operation for compliance with availability and authentication policies. In some embodiments, this is achieved via the log for the instance of software service 202. The policies for which compliance is checked may be determined by analyzing software service (e.g. based on tags identified in the development phase), analyzing the logs from the testing or production phase (e.g. matching patterns of properties for the software service in the logs), and/or using known or default policies. For example, for a particular instance of software service 202, it may be determined whether the network traffic, login information, authentication procedures, and/or authorization procedures comply with policies applicable to software service 202.

Knowledge base 250 stores data related to TMA performed by SSES 200. For example, if SSES 200 utilizes STRIDE, knowledge base 250 stores STRIDE information in knowledge base 250. Thus, knowledge base 250 may be considered define the security methodology. In some embodiments, knowledge base 250 stores data related to threats (e.g. security vulnerabilities) detected by SSES 200. In some embodiments, this threat detection information is stored based on an index and may contain identities of one or more sentinels for the threat, desired property/properties corresponding to the threat, security level(s) for violations of policies/vulnerabilities corresponding to the threat, and mitigating solution(s). In some embodiments, the sentinels are incorporated into and/or utilized by BML 210 and/or SRL 220. During development and runtime (e.g. testing and/or production), BML 210 and SRL 220 use the sentinels to obtain and send the security information to the SSES intelligence 270. BML 250 may store other security information incrementally learned through use of SSES 200. For example, the tags that have been used, the characteristics of software service 202 in which particular tags are used may be stored along with the corresponding threats. Knowledge base 250 can thus be used to identify vulnerabilities and provide security levels and mitigating solutions during development, testing, and/or production of software service 202.

Service security information analytics (SSIA) repository 260 stores the security related information for the current software service 202 and its dependencies. SSIA repository 260 is used to address service and service dependency complexities. For example, SSIA repository 260 may store information related to the activities and traffic for software service 202 for which TMA is performed. Security information stored in SSIA repository 260 can be used to track security for each software service 202. SSIA repository 260 supports big data analysis and searching. Thus, SSIA repository 260 includes information, such as traffic and activity, for each instance of software service 202 and can be used to improve the body of knowledge used by SSES intelligence 270 to make decision and provide enforcement. Thus, SSES 200 can more effectively identify and mitigate the vulnerabilities.

TMA configuration 240 is used in configuring knowledge base 250 and/or SSES intelligence 270. Thus, initial, additional and/or more up-to-date information can be installed in SSES 200 without directly changing BML 210 and SRL 220. Similarly, knowledge base 250 may be configured for particular services. Through this, the monitoring level and toggling in runtime can also be configured.

SSES intelligence 270 may be used to coordinate the activities of SSES 200, monitor operation of software service 202, perform machine learning (e.g. perform pattern recognition), determine of whether policies are violated (e.g. using information from knowledge base 250), provide enforcement, and/or other engage in other activities. For example, machine learning may be utilized to determine which test cases in testing suite 204 are to be used with a particular software service 202, whether software service 202 has properties that sufficiently match the properties of a previously developed software service, and/or which policies are applicable to software service 202. In some embodiments, these activities may be performed and/or coordinated by SSES intelligence 270.

SSES intelligence 270 may also include enforcement mechanisms. In determining the threat level associated with a service vulnerability and the appropriate enforcement (e.g. mitigation) mechanism (e.g. that are consistent with STRIDE), SSES intelligence 270 may utilize information stored in knowledge base 250. To perform TMA in the development, testing, and/or production phases, SSES intelligence 270 utilizes BML 210, SRL 220, knowledge base 250 and SSIA 260. As part of performing TMA, it is determined whether software service 202 complies with applicable policies. If software service 202 does not comply with the policies, then a response indicating a service vulnerability is generated. Thus, the policies are enforced. In some embodiments, enforcement (e.g. the response) may simply include a notification to the developer, administrator, or other authorized user that software service 202 does not comply with one or more policies. As part of this notification, the policy with which software service 202 does not comply may be identified and other information provided. In some embodiments, additional action may be taken. For example, a port used by software service 202 may be shut down, an IP address communicating with software service 202 may be blocked or blacklisted, operation of software service 202 may be suspended or terminated, or other action taken. The action taken may depend upon the security level of the policy that is breached. For a low level policy, a notification and/or temporary suspension of software service may be enforced. For more noncompliance with higher security level policies, more drastic action may be taken. For example, the IP address may be blacklisted and/or operation of software service 202 may be terminated. In some embodiments, changes to source code may be suggested or made automatically (e.g. in response to the developer accepting the suggested change). Thus, part of TMA provided by SSES 200 includes enforcement.

Thus, SSES 200 provides a variety of benefits by performing TMA for software services throughout the life cycle and in a manner that may be automated and data driven. TMA may be more efficient, faster, capable of being used in the CI/CD framework, and able to adapt to new threats. Security visibility is also improved. Enforcement mechanisms may not only address the underlying issue, but also provide notification of and information related to security vulnerabilities. For example, developers and administrators may be notified as to characteristics (e.g. the security level of the vulnerability, the policy or policies violated, and/or the frequency of the violation) of the service vulnerabilities and may be allowed to access information related to the vulnerabilities. In some embodiments, this notification is accomplished via a graphical user interface such as a dashboard provided by SSES intelligence 270. Because SSES 200 provides more effective visibility into security vulnerabilities, poor security standards, low productivity standards, and slow threat-response time may be more readily discovered. Consequently, software services may be more rapidly protected against current and/or potential threats from ransomware, malware, data breaches, and/or other unknown or unseen threats.

SSES 200 may perform TMA at or close to real time and in the testing and production phases. Real time visibility into security vulnerabilities provides an opportunity to address risk before damage to the system escalates. Software services running in the production phase faces numerous potential attacks and risks. The software service environment in the production phase may be dynamic and complicated. TMA using SSES 200 employs feedback and learning from the production phase. As a result, updating of software service 202 may be performed at or near real time to address real situations. Through TMA in the production phase performed by SSES 200, security may be updated and maintained service development and release process, may be integrated with service runtime processes and threads, and allow software service 202 to be agile and developed iteratively. Threat propagation may be prevented or mitigated. Thus, the risk of security breaches may be reduced.

TMA using SSES 200 may be more reliable. Manual processes used in conventional TMA are elementary but error-prone and hard to scale. SSES 200 allows for automated, data driven TMA as well as automatic enforcement. Knowledge gained through operation of software service 202 (i.e. use of SSES 200 in the production phase) may result in incremental learning regarding existing and potential threats. Thus, SSES 200 may be updated, substantially in real time, during use. Thus, TMA using SSES 200 may be less prone to error, faster, and/or adaptable to new threats.

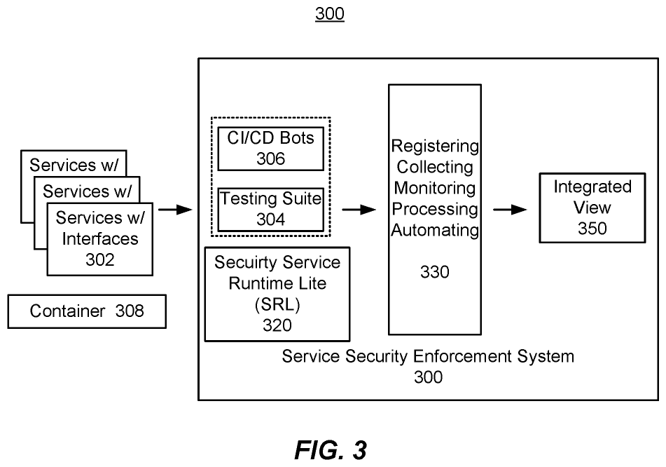

FIG. 3 depicts operation of an embodiment of SSES 300 used in connection with software services 302 during the testing and/or production phases. In some embodiments, SSES 300 indicates how SSES 110 and/or SSES 200 operates. However, other configurations and operation in another manner are possible. For example, tasks indicated as being performed by particular component may be shared with other components and/or incorporated into different component(s).

SSES 300 is shown in conjunction with and interacts with portions of the environment. Thus, FIG. 3 depicts software services 302, testing suite 304, and bots 306. Testing suite 304 and bots 306 may exist outside of SSES 300, but are used in conjunction with SSES 300. Consequently, for the purposes of describing operation of SSES 300, testing suite 304 and bots 306 are depicted as part of SSES 300 but are surrounded by a dotted line. Software services 302, testing suite 304, and bots 306 are analogous to software service 202, testing suite 204 and bots 206 described in connection with FIG. 2. Also shown is container 308 in which software services 302 may reside. For example, container 308 may be a Tupperware or Kubernetes container.

SSES 300 is depicted as including SRL 320, module 330 for performing various functions related to TMA, and integrated view 350. SRL 320 is analogous to SRL 220. Thus, SRL 320 is used in performing TMA during the testing and/or production phases. In some embodiments, SRL 320 utilizes bots 306 to check the software services 302 being run (in testing and/or production) for security vulnerabilities. In some embodiments, SRL 320 utilizes existing service logging in order to perform TMA. More specifically, SRL 320 may fetch the related information from logs generated during operation of the software service 302 (e.g. using bots 306) and provide the log information for use by module 330 in TMA. Thus, module 330 may be analogous to SSES intelligence 270 and, in some embodiments, knowledge base 250. During the testing phase, the log information relates to operation of software services 302 in connection with test cases in testing suite 304. During production, the log information relates to software services 302 during actual use. Software services 302 have also been registered and accepted for testing or use. Because software services 302 are registered, SSES 300 has access to the source code for software services 302. SRL 320 may also use information in tags included in software services 302.

The information related to software services 302 operation during testing and/or production is automatically collected (e.g. by bots 306 during testing with testing suite 304 or in production). In some embodiments, container 308 used for software services 302 also has security information. For example, security information may be extracted from container 308 and container security-related signals may be monitored. Security information for software services 302 and container 308 may also be processed and used in TMA, as indicated by module 330. In some embodiments, module 330 may be considered to perform one or more functions of SSES intelligence 270 in conjunction with knowledge base 250 and/or SSIA repository 260. In addition, container security-related signals may be analyzed to detect anomalies.

Integrated view 350 is provided based on the monitoring, processing, analyzing and other functions of TMA. The integrated view 350 may, for example, be a dashboard in which alerts can be provided, enforcement actions such as blacklisting of IP addresses can be indicated, and/or other aspects of security presented. Thus, the status of and security issues presented by software services 302 may be readily viewed.

Thus, SSES 300 may provide benefits analogous to SSES 110 and/or 200. For example, TMA may be performed in one or more of the development, testing, and production phases. Further, TMA performed via SSES 300 is automated and may learn based on operation of software services 302. Thus, TMA may be more efficient, less error-prone and faster. Because TMA is performed in the production phase, TMA may be rapidly and iteratively performed to incorporate mitigation of security risks for software undergoing CI/CD. Thus, security for software services 302 and the environments in which they operate may be improved.

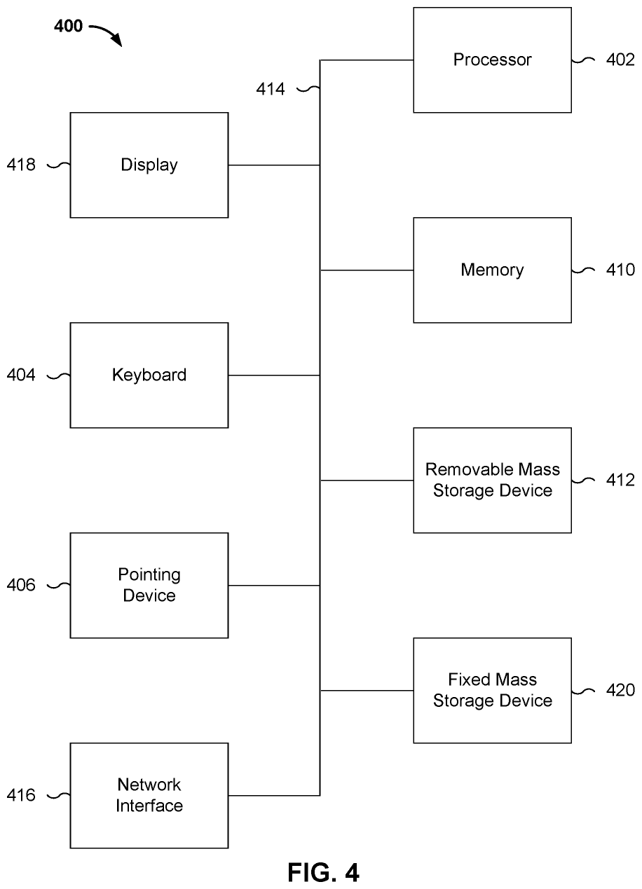

FIG. 4 is a functional diagram illustrating a programmed computer system for executing some of the processes in accordance with some embodiments. As will be apparent, other computer system architectures and configurations can be used as well. Computer system 400, which includes various subsystems as described below, includes at least one microprocessor subsystem (also referred to as a processor or a central processing unit (CPU)) 402. For example, processor 402 can be implemented by a single-chip processor or by multiple processors. In some embodiments, processor 402 is a general purpose digital processor that controls the operation of the computer system 400. Using instructions retrieved from memory 410, the processor 402 controls the reception and manipulation of input data and the output and display of data on output devices (e.g., display 418). In some embodiments, processor 402 includes and/or is used to execute/perform processes 500, 600, 700, and 800 described below.

Processor 402 is coupled bi-directionally with memory 410, which can include a first primary storage, typically a random access memory (RAM), and a second primary storage area, typically a read-only memory (ROM). As is well known in the art, primary storage can be used as a general storage area and as scratch-pad memory, and can also be used to store input data and processed data. Primary storage can also store programming instructions and data, in the form of data objects and text objects, in addition to other data and instructions for processes operating on processor 402. As is also well known in the art, primary storage typically includes basic operating instructions, program code, data and objects used by the processor 402 to perform its functions (e.g., programmed instructions). For example, memory 410 can include any suitable computer-readable storage media, described below, depending on whether, for example, data access needs to be bi-directional or uni-directional. For example, processor 402 can also directly and very rapidly retrieve and store frequently needed data via a cache memory (not shown).

A removable mass storage device 412 provides additional data storage capacity for computer system 400, and is coupled either bi-directionally (read/write) or uni-directionally (read only) to processor 402. For example, storage 412 can also include computer-readable media such as magnetic tape, flash memory, PC cards, portable mass storage devices, holographic storage devices, and other storage devices. A fixed mass storage 420 can also, for example, provide additional data storage capacity. The most common example of mass storage 420 is a hard disk drive. Mass storage 412, 420 generally store additional programming instructions, data, and the like which typically are not in active use by the processor 402. It will be appreciated that the information retained within mass storage 412 and 420 can be incorporated, if needed, in standard fashion as part of memory 410 (e.g., RAM) by virtual memory.

In addition to providing processor 402 access to storage subsystems, bus 414 can also be used to provide access to other subsystems and devices. As shown, these can include a display monitor 418, a network interface 416, a keyboard 404, and a pointing device 406, as well as an auxiliary input/output device interface, a sound card, speakers, and other subsystems as needed. For example, the pointing device 406 can be a mouse, stylus, track ball, or tablet, and is useful for interacting with a graphical user interface.

The network interface 416 allows processor 402 to be coupled to another computer, computer network, or telecommunications network using a network connection as shown. For example, through the network interface 416, the processor 402 can receive information (e.g., data objects or program instructions) from another network or output information to another network in the course of performing method/process steps. Information, often represented as a sequence of instructions to be executed on a processor, can be received from and outputted to another network. An interface card or similar device and appropriate software implemented by (e.g., executed/performed on) processor 402 can be used to connect the computer system 400 to an external network and transfer data according to standard protocols. For example, various process embodiments disclosed herein can be executed on processor 402, or can be performed across a network, such as the Internet, intranet networks, or local area networks, in conjunction with a remote processor which shares a portion of the processing. Additional mass storage devices (not shown) can also be connected to processor 402 through network interface 416.

An auxiliary I/O device interface (not shown) can be used in conjunction with computer system 400. The auxiliary I/O device interface can include general and customized interfaces that allow the processor 402 to send and, more typically, receive data from other devices such as microphones, touch-sensitive displays, transducer card readers, tape readers, voice or handwriting recognizers, biometrics readers, cameras, portable mass storage devices, and other computers.

In addition, various embodiments disclosed herein further relate to computer storage products with a computer readable medium that includes program code for performing various computer-implemented operations. The computer-readable medium is any data storage device that can store data which can thereafter be read by a computer system. Examples of computer-readable media include, but are not limited to, all the media mentioned above: magnetic media such as hard disks, floppy disks, and magnetic tape; optical media such as CD-ROM disks; magneto-optical media such as optical disks; and specially configured hardware devices such as application-specific integrated circuits (ASICs), programmable logic devices (PLDs), and ROM and RAM devices. Examples of program code include both machine code, as produced, for example, by a compiler, or files containing higher level code (e.g., script) that can be executed using an interpreter.

The computer system shown in FIG. 4 is but an example of a computer system suitable for use with the various embodiments disclosed herein. Other computer systems suitable for such use can include additional or fewer subsystems. In addition, bus 414 is illustrative of any interconnection scheme serving to link the subsystems. Other computer architectures having different configurations of subsystems can also be utilized.

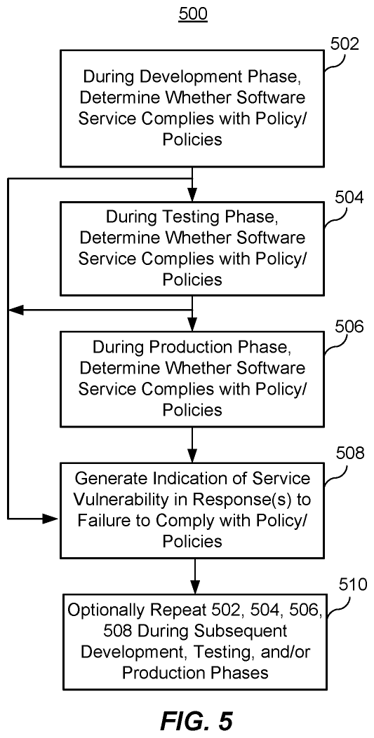

FIG. 5 is a flow-chart depicting an embodiment of method 500 for performing threat modeling analysis for software services. Process 500 is described in the context of SSES 200. In some embodiments, process 500 may be performed by SSES 110 and/or 300. However, in other embodiments, another SSES having another configuration may be used in carrying out method 500.

During the development phase of a software service, it is determined whether the software service complies with one or more policies, at 502. In some embodiments, this determination is made in response to a request. For example, a development tool used in connection with an SSES may be utilized to request TMA be performed. In some embodiments, the software service may be requested to be compiled. In response, it is determined at 502 whether the software service violates applicable policies. In some embodiments, 502 includes determining the policies that are applicable to the software service during development. Thus, TMA is performed during development at 502. If a violation is found, then response(s) indicating there is a service vulnerability are provided, at 508.

During testing of the software service, TMA is performed, at 504. At 504, therefore, it is determined whether the software service complies with certain policies. Thus, operation of the software service is monitored during testing. The policies for which compliance is determined at 504 may include or be distinct from the policies checked at 502. In some embodiments, 504 includes determining the policies that are applicable to the software service during testing. If it is determined that one or more policies are violated during testing, then response(s) indicating service vulnerabilities are provided at 508.

Operation of the software service is monitored during the production phase and compliance of the software service with one or more policies determined, at 506. Thus, TMA is performed during production of the software service. The policies for which compliance is determined at 506 may include or be distinct from the policies checked at 502 and/or 504. In some embodiments, 506 includes determining the policies that are applicable to the software service during production. If it is determined that one or more policies are violated during the production phase, then response(s) indicating service vulnerabilities are provided at 508.

At 508, one or more indication(s) of service vulnerabilities are generated in response to the software service failing to comply with the policy or policies checked at 502, 504 and/or 506. The indication could include a notification of the service vulnerability. The notification might include the policy violated, the seriousness of the policy breached, and/or possible remedies such as changes in the software service. In some embodiments, the indication(s) of the service vulnerabilities includes an action such as suspending operation of the software service, blacklisting an IP address, shutting off access of the software service to a port or data repository, and/or other action. The information relating to the service vulnerabilities may also be stored. This stored security information may be used (e.g. via machine learning) in assessing future software services.

At 510, one or more of 502, 504, 506 and 508 may be repeated. For example, if the software service undergoes CI/CD, then the software service may undergo further development, testing, and releases. Thus, TMA may be continued for the software service beyond its initial release.

For example, software service 202 may be checked for compliance with one or more of policies 208 during development using BML 210 and SSES intelligence 270, at 502. Using SRL 220, operation of software service 202 may be monitored (e.g. via bots 206 and for test cases in testing suite 204) during testing, at 504. Also at 504, it is determined using SSES intelligence 270 whether software service 202 complies with the relevant policies 208 during testing. Similarly, software service 202 may be monitored (e.g. via bots 206) during the production phase using SRL 220, at 506. If it is determined by SSES intelligence 270 that software service 202 fails to comply with one or more of the policies 208 in the development, testing, and/or production phases, then an indication of a service vulnerability is provided, at 508. In some embodiments, SSES 200 provides alert(s), suggests changes to software service 202, terminates operation of software service 202 and/or performs other enforcement as part of the indication of the service vulnerability. For subsequent development, testing and/or production of software service 202, SSES 200 may repeat one or more of 502, 504, 506 and 508. Thus, security may be improved throughout the lifetime of software service 502.

Using method 500, TMA may be performed throughout development, testing, and production of the software service. Further, TMA may be automated and use machine learning in method 500. In addition, since method 500 can be performed again for subsequent development, testing and/or production, TMA may continue throughout the life of the software services.

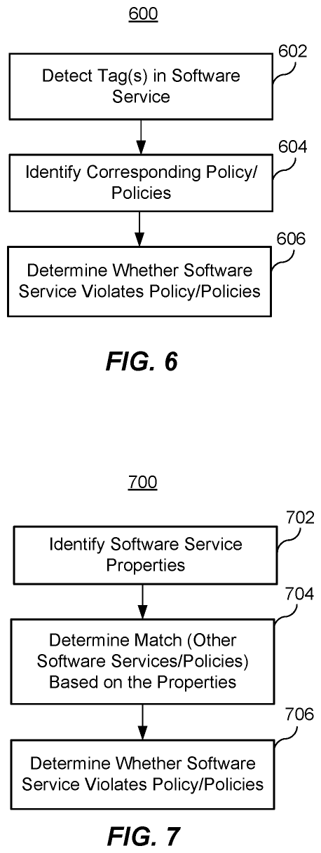

FIG. 6 is a flow-chart depicting an embodiment of method 600 for performing TMA for software services using tags. Process 600 is described in the context of SSES 200. In some embodiments, process 600 may be performed by SSES 110 and/or 300. However, in other embodiments, another SSES having another configuration may be used in carrying out method 600. In some embodiments, method 600 may be considered to implement 502 (TMA during the development phase), 504 (TMA during the testing phase) and/or 506 (TMA during the production phase) of method 500.

Tag(s) with which the software service has been annotated are detected, via 602. For example, during compiling or other analysis of the software service, certain (e.g. predefined) tags are recognized. The policy or policies corresponding to the tags are identified, at 604. At 606, it is determined whether the software service complies with the policy or policies that have been identified. If it is determined in 606 that the software service violates the policy or policies, then an indication of the service vulnerability may be provided, for example using 508 of method 500.

For example, software service 202 may be examined to determine whether software service 202 has been annotated with tags, at 602. In some embodiments, 602 may be performed by a development tool and/or bot(s) 206 in conjunction with BML 210. For example, the AuthN_attribute tag may be located in software service 202. The corresponding policies for the tags are identified, at 604. BML 210 and/or SSES intelligence 270 may be used to determine that token-based authentication is required for software service 202 based on the AuthN_attribute tag. At 606, BML 210 and/or SES intelligence 270 may determine whether software service 202 implements token-based authentication. For some policies that utilize tags, 606 may be performed during testing and/or production using SRL 220 and SSES intelligence 270. In response to a determination that software service 202 is not in compliance with the policy or policies, corrective action, such as providing an indication of the service vulnerability, may be taken. In the example above, if it is determined that token-based authentication is not used, then a notification to the developer requiring a change in the authentication framework and/or suggestions for changes to the code may be provided.

Using method 600, TMA may be performed using tags and/or other analogous annotations in the software service. Thus, security for the software service and the environment in which the software service is used may be improved.

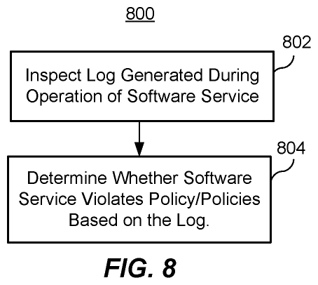

FIG. 7 is a flow-chart depicting an embodiment of method 700 for performing TMA for software services using analysis. Process 700 is described in the context of SSES 200. In some embodiments, process 700 may be performed by SSES 110 and/or 300. However, in other embodiments, another SSES having another configuration may be used in carrying out method 700. In some embodiments, method 700 may be considered to implement 502 (TMA during the development phase), 504 (TMA during the testing phase) and/or 506 (TMA during the production phase) of method 500.

During compiling of the software service, other analysis of the software service, and/or analysis of operation of the software service, properties of the software service are identified, at 702. The policy or policies that match the properties of the software service are determined, at 704. At 706, it is determined whether the software service complies with the policy or policies that have been identified. If it is determined in 706 that the software service violates the policy or policies, then an indication of the service vulnerability may be provided, for example using 508 of method 500.

For example, software service 202 may be analyzed to determine it properties, at 702. In some embodiments, 702 may be performed by a development tool and/or bot(s) 206 in conjunction with BML 210 and/or SRL 220 and SSES intelligence 270. For example, during building of software service 202, calls to particular functions or libraries and/or other features inherent to the code for software service may be determined. Similarly, during operation of software service 202, the type of authentication and/or authorization used, the data repositories accessed, the characteristics of network traffic and/or other properties of software service 202 may be identified. These properties are matched to the properties of other software services or policies 208 by SSES intelligence 270, at 704. For example, a software service having similar (or identical) network usage or which accesses the same data repositories may be identified as part of 704. In some embodiments, the matching process may be carried out by SSES intelligence 270 via machine learning. At 704, the policies which apply to the matching software service are also identified. In some embodiments, the properties of software service may be directly matched to characteristics of policies 208. For example, if software service 202 utilizes sensitive data repositories, the authentication and/or authorization policies for the data repositories may be identified by SSES 200 at 704. At 706, SSES intelligence 270 may be used to determine whether software service 202 complies with the identified policies. In response to a determination that software service 202 is not in compliance with the policy or policies, corrective action, such as providing an indication of the service vulnerability, may be taken. In the example above, if it is determined that token-based authentication is not used, then a notification to the developer requiring a change in the authentication framework and/or suggestions for changes to the code may be provided.

Using method 700, TMA may be performed using tags and/or other analogous annotations in the software service. Thus, security for the software service and the environment in which the software service is used may be improved.

FIG. 8 is a flow-chart depicting an embodiment of method 800 for performing TMA for software services during the testing and/or production phases. Process 800 is described in the context of SSES 200. In some embodiments, process 800 may be performed by SSES 110 and/or 300. However, in other embodiments, another SSES having another configuration may be used in carrying out method 800. In some embodiments, method 800 may be considered to implement (TMA during the testing phase) and/or 506 (TMA during the production phase) of method 500.

During operation of the software service, the log generated for the software service is inspected, at 802. Based on the behavior of the software service as exhibited by the log, it is determined whether the software service complies with policies, at 804. If it is determined in 804 that the software service violates the policy or policies, then an indication of the service vulnerability may be provided, for example using 508 of method 500.

For example, software service 202 may operate in the testing phase (e.g. with test cases in testing suite 206) and/or may operate during actual use in the production phase. During use, a log is generated for software service 202. The log is automatically inspected and information is fetched from the log using SRL 210, at 802. SRL 210 may then be used in determining whether software service 202 violates the corresponding policies. For example, SRL 210 obtains (e.g. from bots 206) security time-series data from the log and sends this data to SSES intelligence 270 to monitor for service availability. SSES intelligence 270 determines whether software service 202 complies with existing policies service availability policies. In response to a determination that software service 202 is not in compliance with the policy or policies, corrective action, such as providing an indication of the service vulnerability, may be taken.

Using method 800, TMA may be performed using tags and/or other analogous annotations in the software service. Thus, security for the software service and the environment in which the software service is used may be improved.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A method, comprising:
determining, in a development phase of a software service, whether the software service complies with a first policy in response to a request;
monitoring, in at least one of a testing phase or a production phase of the software service, whether operation of the software service complies with a second policy; and
generating, based on the determining and the monitoring, an indication of a service vulnerability in response to the software service failing to comply with the first policy in the development phase or failing to comply with the second policy in the at least one of the testing phase or the production phase.

2. The method of claim 1, further comprising:
storing security information for the software service, the security information including the service vulnerability.

3. The method of claim 1, wherein the determining further includes:
detecting a tag for the first policy in the software service;
identifying the first policy based on the tag; and
determining whether the software service complies with the first policy.

4. The method of claim 1, wherein the determining further includes:
analyzing the software service to identify a plurality of properties for the software service;
determining whether the plurality of properties match a plurality of characteristics corresponding to the first policy; and
determining whether the software service complies with the first policy in response to the plurality of properties matching the plurality of characteristics.

5. The method of claim 4, wherein the determining the match further includes:
accessing a database including security information for a plurality of software services.

6. The method of claim 1, wherein the monitoring further includes:
inspecting a log for the software service, the log being generated during operation of the software service in the at least one of the testing phase or production phase; and
determining, based on the log, whether the software service complies with the second policy.

7. The method of claim 1, wherein the first policy and the second policy are the same.

8. The method of claim 1, further comprising:
enforcing the first policy in response to the software service failing to comply with the first policy in the development phase; and
enforcing the second policy in response to the software service failing to comply with the second policy in the at least one of the testing phase or the production phase.

9. A system, comprising:
a memory; and
a processor coupled to the memory and configured to:
determine, in a development phase of a software service, whether the software service complies with a first policy in response to a request;
monitor, in at least one of a testing phase or a production phase of the software service, whether operation of the software service complies with a second policy; and
generate, based on the determination and the monitoring, an indication of a service vulnerability in response to the software service failing to comply with the first policy in the development phase or failing to comply with the second policy in the at least one of the testing phase or the production phase.

10. The system of claim 9, wherein the processor is further configured to:
store security information for the software service, the security information including the service vulnerability.

11. The system of claim 9, wherein to determine whether the software service complies with the first policy, the processor is further configured to:
detect a tag for the first policy in the software service;
identify the first policy based on the tag; and
determine whether the software service complies with the first policy.

12. The system of claim 9, wherein to determine whether the software service complies with the first policy, the processor is further configured to:
analyze the software service to identify a plurality of properties for the software service;
determine whether the plurality of properties match a plurality of characteristics corresponding to the first policy; and
determine whether the software service complies with the first policy in response to the is plurality of properties matching the plurality of characteristics.

13. The system of claim 12, wherein to determine the match, the processor is further configured to:
access a database including security information for a plurality software services.

14. The system of claim 9, wherein to monitor, the processor is further configured to:
inspect a log for the software service, the log being generated during operation of the software service in the at least one of the testing phase or production phase; and
determine, based on the log, whether the software service complies with the second policy.

15. The system of claim 9, wherein the first policy and the second policy are the same.

16. The system of claim 9, wherein the processor is further configured to:
enforce the first policy in response to the software service failing to comply with the first policy in the development phase; and
enforce the second policy in response to the software service failing to comply with the second policy in the at least one of the testing phase or the production phase.

17. A computer program product embodied in a non-transitory computer readable medium and comprising computer instructions for:
determining, in a development phase of a software service, whether the software service complies with a first policy in response to a request;
monitoring, in at least one of a testing phase or a production phase of the software service, whether operation of the software service complies with a second policy; and
generating, based on the determining and the monitoring, an indication of a service vulnerability in response to the software service failing to comply with the first policy in the development phase or failing to comply with the second policy in the at least one of the testing phase or the production phase.

18. The computer program product of claim 17, further comprising computer instructions for:
storing security information for the software service, the security information including the service vulnerability.

19. The computer program product of claim 17, further comprising computer instructions for:
enforcing the first policy in response to the software service failing to comply with the first policy in the development phase; and
enforcing the second policy in response to the software service failing to comply with the second policy in the at least one of the testing phase or the production phase.

20. The computer program product of claim 17, wherein the instructions for determining further include instructions for:
analyzing the software service to identify a plurality of properties for the software service;
determining whether the plurality of properties match a plurality of characteristics corresponding to the first policy; and
determining whether the software service complies with the first policy in response to the plurality of properties matching the plurality of characteristics; and wherein the instructions for monitoring further include instructions for
inspecting a log for the software service, the log being generated during operation of the software service in the at least one of the testing phase or production phase; and
determining, based on the log, whether the software service complies with the second policy.
